(19) United States
(12) Patent Application Publication
(10) Pub. No.: US 2013/0136827 A1
(43) Pub. Date: May 30, 2013

(54) Method and Composition for Increasing The Proportion of Dietary Ingredients That Are Resistant To Degradation by Ruminal Microorganisms

(71) Applicants: James S. Drouillard, Olsburg, KS (US); Dan A. Klamfoth, Charlotte, NC (US); Kevin D. Ingram, Fort Worth, TX (US)

(72) Inventors: James S. Drouillard, Olsburg, KS (US); Dan A. Klamfoth, Charlotte, NC (US); Kevin D. Ingram, Fort Worth, TX (US)

(21) Appl. No.: 13/685,041

(22) Filed: Nov. 26, 2012

Related U.S. Application Data
(60) Provisional application No. 61/563,871, filed on Nov. 28, 2011.

(51) Int. Cl. A23K 1/175; A23K 1/00

(52) U.S. Cl. CPC A23K 1/1753; A23K 1/002
USPC 426/74; 426/285; 426/635

(57) ABSTRACT

Feed ingredients that are otherwise susceptible to degradation by ruminal microorganisms are combined with mineral hydrates (or oxides) and water, and processed through a pin mixer, pellet mill, extruder, or other suitable device to produce agglomerated particles. The ruminant animal feed which is so produced effectively increases the proportion of dietary ingredients presented for digestion and absorption within the post-ruminal digestive tract of the animal by inhibiting premature digestion by microorganisms inhabiting the rumen.

### 1. CROSS REFERENCE TO RELATED APPLICATIONS

The present case claims priority from U.S. Provisional Patent Application Ser. No. 61/563,871, tiled Nov. 28, 2011, by inventors James S. Drouillard and Dan A. Klamfoth, with the same title.

### BACKGROUND OF THE INVENTION

1. Field of the Invention

The present invention relates generally to ruminant feedstocks for domesticated ruminants and, particularly, to such feedstocks which are resistant to degradation by ruminal microorganisms.

2. Description of the Prior Art

Ruminant animals, including cattle, sheep, goats, deer, and buffalo, have a highly specialized and complex stomach, portions of which are inhabited by microorganisms capable of digesting complex carbohydrates, such as cellulose (fiber). The stomach of ruminants is divided into four distinct chambers—the rumen, reticulum, omasum, and abomasum. The first two of these compartments are characterized by the presence of dense populations of symbiotic bacteria, archaea, protozoa, and fungi. These microorganisms are capable of fermenting feeds that are ingested by ruminant animals, ultimately yielding metabolites that can be used by other microorganisms or the host animal. It is this symbiotic relationship that renders ruminants capable of producing milk, meat, and other products while eating fibrous feeds that cannot be digested by pigs, chickens, people, and other simple-stomached, monogastric animals.

One of the challenges in production of ruminant animals is in balancing nutritional, requirements of microorganisms in the gut with those of the host animal. High producing ruminants require substantial quantities of amino acids, energy, vitamins, and minerals to meet demands for production of milk, meat, and (or) fiber. The microbes within the rumen (i.e., reticulo-rumen) are very adept in their ability to degrade carbohydrates, protein, and other constituents of the diet, often to an extent that far exceeds their own nutrient needs. Excessive degradation of nutrients by ruminal microorganisms can result in relative deficiencies of these nutrients for the ruminant host. Protein, amino acids, and certain vitamins are particularly susceptible to microbial degradation within the rumen. As an example, dietary proteins are extensively degraded by microorganisms to yield amino acids, which then are deaminated to yield ammonia. The ammonia is utilized by microflora and fauna of the rumen ecosystem for synthesis of microbial protein, but when produced in excess is absorbed into the bloodstream, converted to urea by the liver, and excreted in urine via the kidneys as a waste product. If excessive degradation is avoided, these amino acids exit the rumen and become available for absorption within the small intestine, thereby contributing to the nutrient requirements of the host animal. Various means have been employed to modify dietary ingredients in ways that decrease their susceptibility to microbial degradation within the rumen, thus increasing the proportion of the compound or ingredient that “bypasses” the rumen, Ruminally undegraded, rumen undegradable, ruminally protected, escape, and bypass all are terms used to describe compounds or products that exhibit some degree of resistance to the digestive actions of microorganisms within the rumen.

In spite of these advances in the relevant arts, a need continues to exist for further improvements in techniques for increasing the proportion of dietary ingredients that are resistant to degradation by ruminal microorganisms.

### SUMMARY OF THE INVENTION

In the method of the present invention, feed ingredients that are otherwise susceptible to degradation by ruminal microorganisms are combined with calcitic and/or dolomitic mineral hydrates generically called hydrated lime as a binder, and typically with a blending aid, such as water. The mixture is then processed through a pin mixer, pellet mill, disc pelletizer, drum pelletizer, extruder, or other suitable device to produce prills or pellets of agglomerated particles.

The hydrated lime which is used in the method of the invention can be a high calcium, dolomitic or partially hydrated dolomitic lime produced in a pressure hydrator or in an atmospheric hydrator. This would include hydrates made from magnesium lime and/or calcitic dolomitic lime, i.e., high calcium lime, magnesium lime, calcitic dolomitic lime and dolomitic lime. While some mixtures of component ingredients used in the practice of the invention will contain the previous components alone, some mixtures will also include a calcitic and/or dolomitic carbonate mineral component, i.e., dolomite, calcium carbonate or magnesium carbonate or mixtures thereof. This method of processing ruminant animal feed and the feed product produced thereby effectively increases the proportion of dietary ingredients present in the feed that are resistant to degradation by ruminal microorganisms.

There are a number of additional processing steps which may be employed, depending upon the desired characteristics of the end product. For example, the agglomerated particles may have a secondary coating applied after agglomeration.

The processing technique can be used to protect other ingredients from the action of ruminal microorganisms. For example, the agglomerated particles may also include lysine, methionine or other amino acids as a means of increasing the proportion of those compounds that are available for absorption in the animal postruminal tract. The agglomerated particles may include choline and water soluble vitamins that may be required by the animal in quantities that exceed those which would normally escape digestion by ruminal microbes. The agglomerated particles so produced may also provide for the protection of monounsaturated or polyunsaturated lipids which normally are extensively biohydrogenated by ruminal microorganisms to yield saturated lipids. The same techniques can be used to provide for the protection of fat soluble vitamins, enzymes, probiotics, prebiotics, carbohydrates, pharmaceuticals, essential oils, minerals, and other compounds which insure that a greater proportion of these products are presented post-ruminally.

Additional objects, features and advantages will be apparent in the written description which follows.

### BRIEF DESCRIPTION OF THE DRAWINGS

FIG. 1 is a graphical representation of the results of an In situ evaluation of the disappearance of dry matter after 24 hours of incubation in the rumen.

FIG. 2 is a graph of fatty acid concentration in plasma of growing steers.

### DETAILED DESCRIPTION OF THE INVENTION

The embodiments herein and the various features and advantageous details thereof are explained more fully with reference to the non-limiting embodiments that are detailed in the following description. Descriptions of well-known components and processes and manufacturing techniques are omitted so as to not unnecessarily obscure the embodiments herein. The examples used herein are intended merely to facilitate an understanding of ways in which the invention herein may be practiced and to further enable those of skill in the art to practice the embodiments herein. Accordingly, the examples should not be construed as limiting the scope of the claimed invention.

In the present invention, “animal feed ingredients” that are otherwise susceptible to degradation by ruminal microorganisms are combined with calcitic and/or dolomitic mineral hydrates generically called hydrated lime as a binder, and typically with a blending aid, such as water. The mixture is then processed through a pin mixer, pellet mill, disc pelletizer, drum pelletizer, extruder, or other suitable device to produce prills or pellets of agglomerated particles. In the case of a pin mixer, a mixture of dry powders will usually be charged to the mixer with water being injected via injection ports on the top of the pin mixer. However, either method of pre-mixing the water or adding the water during processing can be employed. Solubilizable products can be pre-solubilized and then injected with the water via the injection ports (for example, lysine has been successfully processed in this manner, as well as in the standard dry mix manner with water being injected via the injection ports). Semi-dry (pre-wetted) products can also be used in a disc pelletizer or a drum pelletizer. In some cases, water is not required, as where high moisture ingredients are combined with the other dry ingredients. Non-aqueous solvents, such as glycerol, may also be employed in some circumstances.

By “animal feed ingredient” is meant in this discussion that component of the agglomerated will or pellet that would otherwise be susceptible to degradation by ruminal microorganisms/enzymes in the rumen. These ingredients will include such things as biologically active ingredients and/or therapeutic or nutritional agents, as well as those ingredients merely having food value. In addition to those “food ingredients” previously mentioned, such ingredients may include mineral additives such as sodium, potassium, iron, calcium; vitamins such as vitamins A, B, D, etc.; protein/energy producing foods such as milled flax seed, dried blood or meat meal, cottonseed meal, soy meal, canola meal, glucose, fatty acids and yeasts; growth factors; enzymes such as proteases, lipases, or carbohydrases, including but not limited to amylases, lactases, hemicellulases, xyanases, and cellulases; antibiotics; exogenous growth promotans; and food adjuvants such as sodium bicarbonate, sorbitol, propylene glycol and sodium propionate. The “animal feed ingredient” can be thought of as a core material which is embedded or tied up within a matrix consisting of the carbonate/hydrate complex, in other words, a matrix of agglomerated particles.

The hydrated lime which is used in the method of the invention can be a high calcium, dolomitic or partially hydrated dolomitic lime produced in a pressure hydrator or in an atmospheric hydrator. This would include hydrates made from magnesium lime and calcitic dolomitic lime, i.e., high calcium lime, magnesium lime, calcitic dolomitic lime and dolomitic lime.

Preferred calcitic and dolomite mineral hydrates used as binder components for the food ingredients in making the agglomerated particles of the invention thus include both high calcium hydrate and dolomitic hydrate, as well as mixtures of calcium and magnesium hydroxide. The term “hydrated lime” is therefore intended in this discussion to generally encompass all of the following:

High Calcium Hydrate: Hydrated lime (calcium hydroxide, or slaked lime) is a dry powder resulting from the controlled slaking of quicklime with water. The exothermic or released heat of reaction is captured and used to evaporate the excess slaking water. This is to be distinguished from “lime slurry” in which the excess water is not evaporated and the hydrate remains as a water suspension. The chemical formula is Ca(OH)₂.

Dolomitic Hydrate: Dolomitic Hydrate is manufactured from dolomitic quicklime basically by two methods. The first method is similar to high calcium hydrate manufacture and usually does not completely hydrate all the oxides; especially the magnesium oxide component. The second method relates to pressure hydration of dolomitic quicklime under special hydrating conditions that control temperature and, pressure in order to insure that all the calcium and magnesium oxides are fully hydrated. Varieties of hydrates from both methods may be utilized for purposes of the present invention, either those produced by pressure hydrators, or those produced by atmospheric hydrators.”

A spectrum of products of the above type are commercially available from Lhoist North America, 3700 Hulen Street, Fort Worth, Tex. 76107, or from Lhoist operations worldwide.

As has been mentioned, while some mixtures of component ingredients used in the practice of the invention will contain the previous components alone, some mixtures will also include a calcitic and/or dolomitic carbonate mineral component, i.e., calcium carbonate or magnesium carbonate or dolomite or mixtures thereof. The addition of such a mineral component generally helps in the ultimate prill formation and also yields a stronger prill. Other minerals such as selenium may be included, as well as aluminum containing compounds. In some cases, mineral oxides, e.g., calcium oxide or magnesium oxide, may also be present.

Preferred binder compositions of the invention will thus typically be comprised of hydrated lime in combination with a companion material or materials, such as, for example, a dolomitic or calcitic limestone. By way of an example, the binder composition can contain about 40% by weight of hydrated lime and 60% by weight dolomitic limestone or dolomite. An example dolomitic limestone is Applicant's “ProMg™ 95” dolomitic limestone which is commercially available from Lhoist North America. Other companion materials include clay(s), magnesium oxide, magnesium carbonate (magnesite) and magnesium hydroxide (brucite). In other circumstances, the binder is made up of the hydrated lime alone with the animal feed ingredient.

When combined with the binder component or components of the invention and processed as described, a matrix of agglomerated particles is produced. The end result may be either a pellet or mill as those terms are commonly understood. A “pellet” typically takes the form of a rod or cylinder, while a “prill” will be taken to mean a small aggregate of a material, most often a dry sphere which is a solid a room temperature. As has been mentioned, it is useful to think of the products of the invention as having a core material (the animal feed ingredient) which is embedded or tied up within a matrix consisting of the carbonate/hydrate complex.

The manufacturing process for manufacturing the agglomerated pellets/pills of the invention will now be described in greater detail. Table I below gives the settings used for a pin mill in manufacturing the agglomerated particles of the invention. A “pin mill or pin mixer” will be understood by those skilled in the relevant arts to be a high speed, conditioning and micro-pelletizing device that converts powders into small agglomerates through the action of a high speed rotor shaft and pin assembly, with the addition of liquids such as water, binders, oil or surfactants.

TABLE I
Production Run - Settings
50% Dolomitic Hydrate (pressure hydrated)/50% Milled Flax Seed

| Material Feed Rate | | Nozzle | | Water | | Pin Mixer | | | Green Pellets | | |
|---|---|---|---|---|---|---|---|---|---|---|---|
| ft3/hr | lbs/min | tip* | psi | gal/min | lbs/min | freq.(RPM) | Current(Amps) | Power(hp) | Temp(F.) | % Moisture | bulk density** |
| 6.1 | 3.0 | 4002 | 15 | 0.146 | 1.222 | 1300 | 22 | 9 | 135 | 24.4% | 34.5 |

*4002 tip-applies 0.2 gallons of water per minute in a 40 degree flat spray pattern (at 40 psi)
**Aerated bulk density (lbs/ft³)

Table II below gives the raw material properties for the raw ingredients fed to the pin mixer.

TABLE II
Raw Material Properties (Pre-Run)

| | | | Bulk Density |
|---|---|---|---|
| | % Moisture | Bulk Density | Compacted) |
| Product | Content | (Aerated) (lb/ft³) | (lb/ft³) |
| Dolomitic Hydrate | 1.2% | 21.1 | 30.9 |
| Milled Flax Seed | 6.6% | 25.4 | 38.2 |
| 50% DH/50% MFS - | 3.9% | 29.7 | 41.7 |
| pre-mix | | | |

Table III gives the size distribution information for the milled flax seed which comprises the “animal feed ingredient” which is to be protected from ruminal degradation. Milled flax seed is a commonly available product which can be produced, for example, by processing with a hammer mill. Flax seeds contain high levels of dietary fiber as well as lignans, an abundance of micronutrients and omega-3 fatty acids.

TABLE III
Milled Flax Seed Sizing

| Sieve Size | % Retained | % Cumulative (Retained) |
|---|---|---|
| 10 mesh | 0.0% | 0.0% |
| 45 mesh | 71.0% | 71.0% |
| 80 mesh | 20.5% | 91.5% |
| 120 mesh | 7.0% | 98.5% |
| 200 mesh | 1.5% | 100.0% |
| 325 mesh | 0.0% | 100.0% |
| Pan | 0.0% | 100.0% |

Tables IV and V below give the finished pellet properties of the pellets produced with the pin mixer:

TABLE IV
Finshed Pellet Properties

| | Bulk Density (lb/ft³) | | % Attrition | Comp. Strength |
|---|---|---|---|---|
| % Moisture* | (Aerated) | (Compacted) | Loss** | (avg.pounds)***) |
| 0.5% | 36.2 | 45.2 | <0.3% | 10.7 |

*Lab-dried samples at 90° C.
**Measured as % loss of −16 × 20 mesh after 5 mins on 30 mesh screen (Ro-Tap)
**Conducted on 1/8″ prills/pellets (7 samples—highest & lowest dropped)

TABLE V
Finished Pellet Size Distribution
(0.5% moisture - 90° C. lab dried samples)

| Sieve Size | % Retained | % Cumulative (Retained) |
|---|---|---|
| 14 mesh | 69.2% | 69.2% |
| 16 mesh | 9.2% | 78.4% |
| 20 mesh | 10.3% | 88.7% |
| 45 mesh | 10.3% | 99.0% |
| 80 mesh | 0.6% | 99.6% |
| 120 mesh | 0.2% | 99.8% |
| pan | 0.2% | 100.0% |

The pellets of agglomerated particles so prepared were then used in two test evaluations of the efficacy of the method of the invention in protecting feed ingredients from degradation that would otherwise occur in the animal rumen. The first evaluation was an “in situ” trial. The test pellets were 50% dolomitic lime hydrate/50%, milled flax seed; 75% lime hydrate/25% milled flax seed; and 90% lime hydrate/lysine, respectively. They are compared with flax seeds or lysine alone.

### Evaluation No. 1:

The in situ procedure utilizes small in situ bags made of a nitrogen-free synthetic polyester fabric (Dacron®; Ankom Technology, Mecedon, N.Y.) that has a 50 μm pore size. The pores are sufficiently small such that when feed materials are placed into the bag the contents are retained. The pore size also is large enough to allow for entry of microorganisms into the bag when placed into the rumen, thus exposing the contents to the degradative actions of ruminal microbes. Disappearance of feed particles from the bag is presumed to be due to microbial fermentative activity whilst the bag and its contents are suspended within the rumen environment. In situ assays provide useful information regarding the susceptibility of feeds to microbial digestion within the rumen.

The test procedure consisted of adding 12 g of sample (as is) to Dacron bags, which then were heat sealed and subsequently placed into the rumen and allowed to incubate for 24 hours. Bags then were removed from the rumen, dried and weighed to determine disappearance of dry matter. Concentrations of protein, total fatty acids, and fatty acid profile were determined for the residue from each sample. Samples were prepared in duplicate within each animal, along with blank bags for correction, and six animals were used. Three cattle were fed a high-concentrate diet and 3 were fed a high-forage, i.e., low concentrate diet.

Table VI summarizes dry, matter contents, and well as the as-fed and dry matter concentrations of crude protein and total fatty acids for pure ground flaxseed, the 50:50 flaxseed Lime mixture, the 75:25 Flaxseed/Lime mixture; the 90:10 Lime/Lysine mixture, and pure lysine hydrochloride prior to in situ fermentation. These values were used to calculate the extent of dry matter and nutrient disappearance during the in situ digestion procedure.

TABLE VI

| | | | | Crude | |
|---|---|---|---|---|---|
| | | Total | | Protein | |
| | Dry | Fatty | Crude | (% Dry | Total Fatty |
| | Matter | Acids | Protein | Matter | Acids (% Dry |
| Product | (%) | (%) | (%) | Basis) | Matter Basis) |
| Flaxseed | 93.73 | 43.653 | 22.375 | 23.872 | 46.573 |
| 50/50 | 98.16 | 10.281 | 10.165 | 10.356 | 10.474 |
| Flaxseed | | | | | |
| 75/25 | 98.23 | 7.510 | 5.995 | 6.103 | 7.645 |
| Flaxseed | | | | | |
| 90/10 Lysine | 98.75 | 0.085 | 8.864 | 8.976 | 0.086 |
| Lysine | 99.38 | | 15.337 | 15.433 | |

Table VII summarizes the percent disappearance of dry matter from in site bags during a 24-hour period of ruminal incubation. Two sets of donor animals were used (High Forage/Low Concentrate and High Concentrate/Low Forage) to evaluate disappearance under varying ruminal conditions. The column identified as “Mean” represents the average of the Low and High concentrate groups. Flaxseed in its unprotected form was between 47.95 and 61.38% ruminally degraded (mean of 54.66%), whereas disappearance of the Lime/Flaxseed mixtures ranged from 5.16 to 14.42%, with the greater proportion of lime (i.e., 75%) yielding the greatest ruminal stability Unprotected lysine was almost completely degraded (≧99.83%), whereas the lime/lysine mixture was substantially more stable within the rumen.

TABLE VII
In situ dry matter disappearance (%) after 24 hours of incubation.

| | In situ dry matter disappearance (%) | | |
|---|---|---|---|
| Product | Mean | Low Concentrate | High Concentrate |
| Flaxseed | 54.66 | 61.38 | 47.95 |
| 50/50 Flaxseed | 13.38 | 14.42 | 12.34 |
| 75/25 Flaxseed | 5.66 | 5.16 | 6.17 |
| 90/10 lysine | 25.90 | 34.90 | 16.90 |
| Lysine | 99.86 | 99.88 | 99.83 |

Table VIII summarizes the fatty acid contents of the unprotected and protected flax products after 24-hours of in situ incubation. These values were used in conjunction with information from Tables VI and VII to calculate the proportion of fatty acids that were retained through the in situ incubation, which are summarized in Table IX. On average, less than 34% of fatty acids remained after the 24-hour incubation of unprotected flaxseed (range of 27.27-39.95), whereas more than double this amount was retained for the protected flax products.

TABLE VIII
Total fatty acids (%) in residue after 24 hours of incubation

| | Total FA (%) | | |
|---|---|---|---|
| Product | Mean | Low Concentrate | High Concentrate |
| Flax | 34.33 | 32.74 | 35.93 |
| 50/50 Flax | 8.98 | 8.38 | 9.58 |
| 75/25 Flax | 5.59 | 5.55 | 5.64 |

TABLE IX
Ruminal escape of fatty acids (%) after 24 hours of incubation

| | Total FA Escape (%) | | |
|---|---|---|---|
| Product | Mean | Low Concentrate | High Concentrate |
| Flaxseed | 33.609 | 27.265 | 39.953 |
| 50/50 Flaxseed | 74.434 | 68.558 | 80.310 |
| 75/25 Flaxseed | 68.981 | 68.827 | 69.135 |

Table X illustrates the concentrations of protein of residue retained in the bags following 24 hours of ruminal incubation. Note that values are zero for the unprotected lysine, indicating that 100% of the material disappeared from the bag. Information in Table X was used in conjunction with data in Tables VI and VII to calculate the fractions of protein that were resistant to ruminal degradation (i.e., ruminal escape protein), which are summarized in Table XI. Lysine in its unprotected form was completely degraded, while the lime treated products were substantially more resistant to degradation. Similarly, protein in the protected forms of flaxseed was approximately 2.5-fold more resistant to degradation during the 24-hour in situ incubation period, indicating that the method has substantial efficacy for protecting nutrients against microbial digestion.

TABLE X
Crude protein (%) of residue after 24 hours of incubation.

| | Crude protein (%) | | |
|---|---|---|---|
| Product | Mean | Low Concentrate | High Concentrate |
| Flaxseed | 17.003 | 17.150 | 16.855 |
| 50/50 Flaxseed | 9.758 | 9.626 | 9.889 |
| 75/25 Flaxseed | 5.291 | 5.332 | 5.251 |
| 90/10 lysine | 2.255 | 1.458 | 3.052 |
| Lysine | 0 | 0 | 0 |

TABLE XI
Ruminal escape of crude protein (%) after 24 hours of incubation.

| | Crude Protein Escape (%) | | |
|---|---|---|---|
| Product | Mean | Low Concentrate | High Concentrate |
| Flaxseed | 32.184 | 27.774 | 36.594 |
| 50/50 Flaxseed | 81.618 | 79.517 | 83.719 |
| 75/25 Flaxseed | 81.784 | 82.848 | 80.720 |
| 90/10 lysine | 19.456 | 10.622 | 28.291 |
| Lysine | 0 | 0 | 0 |

Table XII summarizes the fatty acid profiles of residues after 24-hour in situ incubation. Notable differences are seen with C18:1n9t, C18:1n11, and C18:2n6t, all of which are formed during partial biohydrogenation of alpha-linolenic acid or linoleic acid by ruminal microbes. In each case, values are lower for the protected forms of flaxseed, indicating that the matrix was an effective microbial barrier. Most notable is the increase in C18:3113 (i.e., linolenic acid), which is the predominant polyunsaturated fatty acid in flaxseed. Compared to the unprotected form of flaxseed, the lime matrix increased retention of this fatty acid by between 67 and 116%.

TABLE XII
Fatty acids appearing in residue following 24 hours of incubation,
expressed as a percent of the amount initially placed into the rumen.
Values are the result of conversion from one fatty acid to
another (i.e., biohydrogenation).

| | | 50/50 | 75/25 |
|---|---|---|---|
| Fatt Acid¹ | Flaxseed | Flaxseed | Flaxseed |
| C10:0 | 178.44 | 78.90 | 399.13 |
| C11:0 | 106.54 | 99.75 | 359.55 |
| C12:0 | 55.05 | 163.50 | 243.53 |
| C14:0 | 68.05 | 124.24 | 132.99 |
| C14:1 | 97.59 | 153.02 | 103.33 |
| C15:0 | 90.76 | 159.93 | 162.38 |
| C15:1 | 17.55 | 90.38 | 69.15 |
| C16:0 | 46.39 | 88.19 | 92.00 |
| C16:1 | 46.81 | 87.41 | 86.51 |
| C17:0 | 55.31 | 92.12 | 113.38 |
| C17:1 | 66.36 | 121.55 | 62.36 |
| C18:0 | 47.72 | 95.24 | 105.45 |
| C18:1n9t | 429.68 | 97.27 | 267.77 |
| C18:1n11 | 416.38 | ND | ND |
| C18:1n9c | 36.49 | 72.42 | 77.44 |
| C18:1n7 | 36.86 | 56.31 | 67.84 |
| C18:2n6t | 414.04 | 40.30 | 59.17 |
| C18:2n6c | 30.31 | 69.39 | 60.18 |
| 18:2c9, t11 | ND | Conjugated | 185.96 |
| | | linoleic acid, | |
| | | 80.83 | |
| Conjugated linoleic acid, 18:2t10, | ND | 107.68 | 161.15 |
| c12 | | | |
| Conjucated linoleic acid, 18:2c9, | 87.53 | 182.57 | 141.90 |
| c11 | | | |
| Conjugated linoleic acid, 18:2t9, tll | 151.86 | 84.78 | 158.95 |
| C18:3n6 | 35.93 | 123.44 | 126.60 |
| C18:3n3 | 30.33 | 65.41 | 50.78 |
| C20:0 | 38.55 | 87.61 | 85.22 |
| C20:1 | 44.71 | 122.91 | 160.07 |
| C20:2 | 31.55 | 88.97 | 161.76 |
| C20:3n6 | 28.17 | 173.59 | 254.02 |
| C20:4n6 | 28.56 | 55.86 | 44.99 |
| C20:5n3 | 10.39 | 55.90 | 122.39 |
| C22:0 | 55.63 | 135.60 | 78.54 |
| C22:5n3 | 10.46 | 61.53 | 132.75 |
| C22:6n3 | 104.12 | 99.00 | 79.02 |
| C24:0 | 38.74 | 70.36 | 89.69 |
| C24:1 | 66.78 | 57.36 | 68.40 |

ND: not detected
¹The notation used to identify fatty acids is as follows: The number immediately following the letter “C” indicates the number of carbon atoms in the fatty acid chain. The number immediately following the colon indicates the number of double bonds between carbon atoms in the fatty acid chain (i.e., degree of saturation). Omega 3 fatty acids are denoted as “n3”. omega 6 fatty acids as “n6”, and so on. The cis and trans configurations of double bonds are denotedas “c” and “t”.

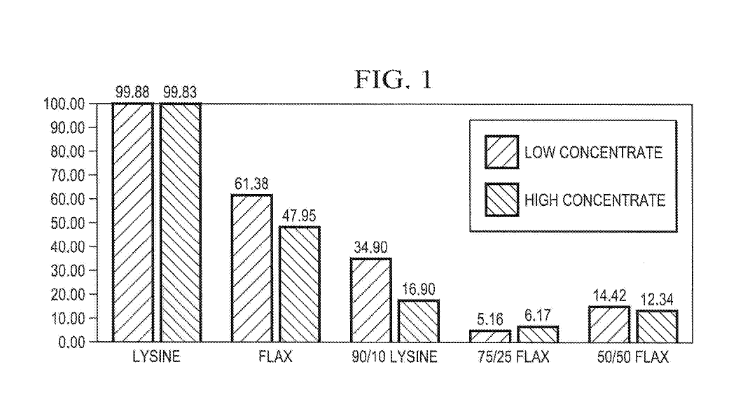

The results of the first evaluation are illustrated graphically in FIG. 1 of the drawings. The in situ dry percentage disappearance can be seen to be dramatically lower for the co-prilled milled flaxseed/lime hydrate trials or even for lysine/lime hydrate trial, compared to flax seeds or lysine alone.

In the next evaluation, a study was conducted to determine if feeding milled flaxseed co-prilled with dolomitic hydrate and dolomitic carbonate will decrease biohydrogenation of polyunsaturated fatty acids by rumen microorganisms, thus increasing their concentrations within the mien blood.

### Evaluation No. 2:

Procedure: Forty-five steers were blocked by weight, randomly assigned to individual pens, and pens to dietary treatments (15 replicates). Steers were fed for 14 days with a basal diet consisting of 30.0% wet corn gluten feed, 25% wheat straw, 25% prairie hay, 12.78% steam-flaked corn, and 3.02% supplement. In treatments 2 and 3, a portion of flaked corn was replaced with 179% flaxseed or 8.13% of a blend of Lime and Flaxseed according as shown in Table 1. Corn oil was included to provide for similar fat concentrations in the three diets. Diets were formulated to provide at least 12% crude protein, 300 mg/day monensin, 1000 IU/lb vitamin A. 0.1% added sodium, and 0.15% added chlorine, 0.7% calcium, 0.7% potassium, and 10 ppm of Cu, Weights of unconsumed feed (orfs) were determined every day.

Weekly samples of feeds were taken and composited sample per treatment that was analyzed for dry matter (DM), organic matter (OM), crude protein (CP), neutral detergent fiber (NDF), and total lipids. Blood samples were taken from the jugular vein for analysis of long chain fatty acid (LCFA) concentrations on day 0, 7, and 14 of the study, Heparinized vacuum tubes (green top) were used which immediately placed on ice and centrifuged (1200×g for 20 min). On day 16 of the study, and 3 h after feeding, samples of ruminal fluid and ruminal headspace gas were taken by rumenocentesis in order to determine ruminal pH, LCFA profile of ruminal digests, and gas composition.

Data were statistically analyzed using the MIXED procedure of SAS (Version 9.0) with treatment and day as fixed effects, barn nested within strata, barn as the random effect, and animal as the experimental unit.

TABLE XIII
Diets.

| | | | | Flaxseed/ |
|---|---|---|---|---|
| Ingredients, % | Pre-experiment | Control | Flaxseed | Lime |
| Wet corn gluten feed | 30.00 | 30.00 | 30.00 | 30.00 |
| Wheat straw | 25.00 | 25.00 | 25.00 | 25.00 |
| Prairie hay | 25.00 | 25.00 | 25.00 | 25.00 |
| Steam flaked corn | 10.36 | 12.78 | 12.86 | 8.50 |
| Linseed meal | — | 3.01 | 1.22 | 1.51 |
| Corn oil | — | 1.19 | 0.1 | — |
| Flaxseed | — | — | 2.79 | — |
| Lime/Flax | — | — | — | 8.13 |
| Glycerin | 5.00 | — | — | — |
| Supplement^{a} | 4.64 | 3.017 | 3.027 | 1.867 |

^{a}Formulated to provide 300 mg/day monensin, 1000 IU/lb vitamin A, 0.1% added sodium, and 0.15% added chlorine, 0.7% calcium, 0.7% potassium, and 10 ppm copper.

### Results:

TABLE XIV
Feed intake and ruminal pH.

| | Control | Flaxseed | Flax/Lime | SEM | P value |
|---|---|---|---|---|---|
| Initial weight, lb | 556.5 | 556.4 | 556.8 | 26.2 | 0.7859 |
| Feed intake (dry | 14.29 | 13.81 | 13.40 | 0.41 | 0.2032 |
| basis), lb | | | | | |
| Ruminal pH | 7.00 | 7.02 | 7.04 | 0.069 | 0.8396 |

TABLE XV
Fatty acid concentrations in plasma (μg/ml) of growing steers.

| | Control | | | Flaxseed | | | Flaxseed/Lime | | | | P value | | |
|---|---|---|---|---|---|---|---|---|---|---|---|---|---|
| Item | Day 0 | Day 7 | Day 14 | Day 0 | Day 7 | Day 14 | Day 0 | Day 7 | Day 14 | SEM | Day | Trt | Day*Trt |
| C16:0 | 73.1 | 79.1 | 76.9 | 76.6 | 78.9 | 74.6 | 74.7 | 84.4 | 88.9 | 3.2 | 0.0194 | 0.0109 | 0.0805 |
| C18:0 | 122.6 | 148.9 | 130.1 | 125.6 | 149.0 | 126.3 | 124.9 | 151.4 | 147.5 | 6.2 | <0.0001 | 0.1586 | 0.3152 |
| C18:1 | 76.8 | 92.0 | 83.1 | 80.8 | 87.3 | 86.5 | 80.1 | 794 | 86.4 | 4.8 | 0.1018 | 0.7244 | 0.3468 |
| C18:2 | 300.4 | 287.6 | 311.3 | 277.2 | 265.5 | 260.7 | 292.7 | 303.5 | 336.9 | 13.2 | 0.1791 | <0.0001 | 0.1389 |
| C18:3n³ | 0.00 | 0.00 | 0.00 | 0.00 | 18.9 | 29.7 | 0.0 | 77.8 | 87.0 | 2.7 | <0.0001 | <0.0001 | <0.0001 |

Alpha-linolenic acid (C18:3n3; also commonly referred to as ALA) is regarded as an essential nutrient for most animals, meaning that the body is incapable of synthesizing the fatty acid in quantities sufficient to fulfill nutritional requirements of animals, thus indicating that it must be included as part of the animal's diet. This fatty acid is utilized as a precursor for synthesis of other important long-chain fatty acids, including eicosapentaenoic acid and docosahexaenoic acid (EPA and DHA), as well as in the synthesis of cholesterol, steroid hormones, eicosanoids, and other important compounds. This polyunsaturated fatty acid typically is subject to extensive biohydrogenation (thus yielding stearic acid) by microorganisms within the rumen ecosystem, as taught by Montgomery et al., who have shown that less than 5% of dietary ALA is available for absorption in the postruminal digestive tract. See, Montgomery S P, Drouillard J S, Nagaraia T G, Titgemeyer E C, Sindt J J., 2008, “Effects Of Supplemental Fat Source On Nutrient Digestion and Ruminal Fermentation In Steers”; J Anim Sci. 86(3):640-50. Alpha-linolenic acid is present in immature cool-season grasses, legumes, and some forbs species, but is relatively deficient in mature forages, cereal grains, and many oilseeds. Flaxseed is an oilseed grown in temperate climates that is a rich source of alpha linolenic acid, containing approximately 40-45% oil, roughly 55-60% of which is in the form of ALA. Concentrations of linolenic acid in blood plasma are more-or-less linearly associated with dietary concentrations of the fatty acid, thus making flaxseed an ideal candidate for evaluating efficacy of the method for protecting nutrients from the actions of microorganisms within the forestomachs of ruminant animals.

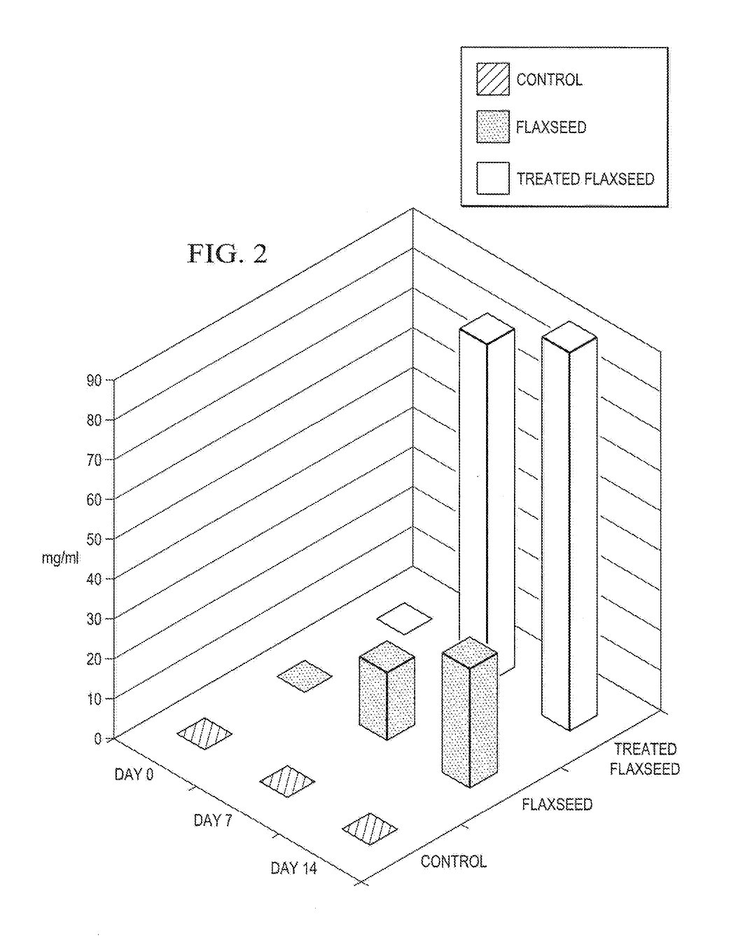

FIG. 2 of the drawings illustrates differences in blood concentrations of alpha-linolenic acid in animals fed different diets. During the pretrial period all animals were fed a basal diet containing low levels of ALA, thus leading to low plasma concentrations of ALA in all treatment groups on Day 0 of the experiment. From day 1-14, all cattle were fed a common basal diet, but the flaxseed and flaxseed/lime treatment groups were supplemented with an equivalent amount of flaxseed in the unprotected and protected forms, respectively. On days 7 and 14 of the experiment, plasma concentrations of ALA remained low in the Control group, but increased sharply in the groups fed flaxseed. Moreover, compared to cattle fed the unprotected form of flaxseed, plasma concentrations of ALA were 412 and 292% greater for the Flaxseed/Lime treatment groups on days 7 and 14, respectively. These results clearly illustrate that the method was successful in rendering a greater proportion of the dietary ALA resistant to biohydrogenation by ruminal microorganisms.

As expected, fatty acid concentrations among treatments were similar at day 0 of the experiment (prior to administration of dietary treatments). Differences among treatments were readily apparent after 7 and 14 days of supplementing the flaxseed and the prilled flaxseed/lime mixture. Most notable are the elevated concentrations of alpha linolenic acid (C18:3n3) for the prilled flaxseed/lime treatment, indicating that the process decreased susceptibility of the flaxseed to microbial biohydrogenation within the reticulo-rumen.

One particular advantage of the method of the invention might be referred to as the “self-healing” nature of the agglomerated particles which are produced in as far as their ability to protect core nutrients/compositions from degradation by ruminal microorganisms. Prior art products known to Applicant applied such things as fats (Balchem's protected choline), synthetic polymers (Adisseo's protected lysine and methionine) or proteinaceous films to the surface of the core material, thus encasing the core materials and serving as a protective barrier. Efficacy of these products is limited, however, due to the propensity for the outer shell to become fractured, thus exposing the core material to ruminal microorganisms. In the method of the present invention, a product is produced in the nature of a core material embedded within a matrix consisting of the carbonate/hydrate complex. Within the rumen, the material is exposed to relatively high concentrations of carbon dioxide, which further “re-carbonates” the surface to form an impervious outer layer. Fracturing of the prills is inevitable during, feed processing and as a result of mastication by the animal. However, in the case of the method of the invention, the unprotected surfaces of fractured materials become carbonated through exposure to carbon dioxide in the rumen.

By creating a homogeneous or semi-homogeneous matrix, the present inventive method allows the intimate contact of active binder and coating material with the bypass material. Hydrated lime of all forms will readily react with CO₂ to form calcium carbonate. In a wet CO₂ environment, such as the animal rumen, this reaction will proceed quickly. Any surface that is alkaline due to the hydrate will react in these conditions, whether they are the outsides of non-coated prills, the surfaces in cracks or fresh surfaces brought about by degradation in handling or consumption. The formation of fresh calcium carbonate will passivate the surfaces and protect them from further ruminal degradation not only due to the creation of a chemically neutral surface, but also due to the increase in volume of the calcium compound as it recarbonates. The effect is somewhat like that achieved with dolomitic lime in construction applications. Dolomitic hydrated lime is specified for use in mortars and stuccos in earthquake zones due to its ability to recarbonate, fill in microcracks due to this volumetric expansion, and prevent the coalescing of these cracks into big cracks that lead to failures. The method of the present invention thus uses a special hydrated lime binder to create a matrix with an ability to repair defects while in the animal rumen, an effect not achieved with the products of the prior art. Additionally, any of the binder that does abrade, break off or dissolve will provide positive rumen buffering.

While the invention has been described in several preferred forms, those skilled in the relevant arts will recognize that various modifications can be made while still falling within the scope of the invention as defined in the claims which follow. For example, the controlling parameters of these manufacturing processes can be modified or altered to adjust the finished characteristics of the agglomerated particles. Those characteristics which can be modified include, but are not necessary limited to, the particles apparent density, particle size, particle porosity all of which can impart or retard certain characteristics which are deemed beneficial or detrimental to their use as discussed in the body of this invention. Additional control of the finished materials' characteristics may be modified by a secondary coating or a layering of a secondary coating.

When fed to ruminants, the particles are exposed to the aqueous, CO₂-rich environment of the rumen, and chemical hydrates on the surface of the particle are recarbonated to form CaCO₃. MgCO₃, or other chemical carbonates, which are substantially resistant to degradation within the rumen. The re-carbonated surface serves as an effective barrier to microorganisms, preventing access to feed ingredients or other components imbedded within the agglomerated particles. The agglomerated particles, or fragments thereof, are passed from the rumen, through the omasum, and into the abomasum where they are exposed to gastric hydrochloric acid secretions. In the presence of hydrochloric acid the carbonates are dissolved, releasing the feed ingredients or other components embedded therein. Components released from the matrix are then available for digestion and absorption or other actions in the post-ruminal digestive tract.

As has been explained, the preferred process utilizes mineral hydrates (hydroxides) as the binder for the matrix-forming materials. Where it may be suitable to release some proportion of the agglomerated material within the rumen, the matrix would be presented to the animal in its hydrated (or partially hydrated) form without prior re-carbonation, thus depending on the ruminal environment to generate a protective carbonate layer on the particle surface, and in so doing releasing a portion of the matrix material. Where it is desired to minimize release of materials within the rumen, hydrates may be exposed to carbon dioxide during the manufacturing to yield products that contain a greater proportion of mineral carbonates that are more-or-less ruminally inert. As an alternative, it is conceivable to utilize carbonates directly for preparation of the matrix.

The process is suitable for increasing the proportion of dietary ingredients presented for digestion and absorption within the post-ruminal digestive tract by inhibiting premature digestion by microorganisms inhabiting the rumen. The method can be applied to lysine, methionine, or other amino acids as a means of increasing the proportion of these compounds that are available for absorption in the postruminal tract, thus improving nutritional status of the host.

Aluminum compounds may also be included in the binder compositions in some cases.

Similarly, the process can be applied for choline and/or water soluble vitamins, vitamins, including ascorbic acid (vitamin C), vitamin including B₁ (thiamine), B₂ (riboflavin), B₃ (niacin or niacinamide), B₅ (pantothenic acid), B₆ (pyridoxine, pyridoxal, or pyridox amine, or pyridoxine hydrochloride), B₇ (biotin), B₉ (folic acid), and B₁₂ (cobalamins; commonly cyanocobalamin), all of which are highly susceptible to extensive hydrolysis by ruminal microorganisms, and that may be required by the host animal in quantities that exceed those which normally escape digestion by ruminal microbes.

The method also has application for the protection of monounsaturated or polyunsaturated lipids, which normally are extensively biohydrogenated by ruminal microorganisms to yield saturated lipids. Complexing lipids in the manner described herein decreases the extent of biohydrogenation of unsaturated fatty acids, thereby making it feasible to increase the proportion of unsaturated fats in meat, milk, and animal fats. As examples, animal products can be enriched with omega-3 fatty acids, conjugated linoleic acids, or other fatty acids deemed useful as nutrients for humans and other animals. As a further consideration, unsaturated fats and derivatives thereof may be toxic to ruminal microorganisms, and when present in excess can decrease digestion of other components of the diet, especially fiber. Complexing lipids using the method described herein avoids interaction between lipids and ruminal microorganisms, thus maintaining more optimal digestion of fibrous feeds and other ingredients that may otherwise be impaired in the presence of unsaturated lipids. In the postruminal digestive track polyunsaturated fats generally are more digestible than saturated fats, thus yielding more energy for the animal. Preventing extensive biohydrogenation of lipids thus represents a means of improving energy value of fats for ruminants.

Mineral elements also constitute a logical target for protection. For example, sodium selenite, which is a relatively available source of essential selenium, is utilized by ruminal microorganism to synthesize selenocysteine, which has relatively poor bioavailability in the post-ruminal digestive tract. Protecting selenium within the mineral matrix precludes interaction with ruminal microbes, preserving the more available form of this essential mineral. Minimizing interactions between mineral elements and ruminal microorganisms may have other advantages, as well. For instance, heavy metals such as zinc, copper, and manganese are capable of inducing antimicrobial resistance among microorganisms exposed to these elements, thus impacting efficacy of important antimicrobial drugs. By embedding the heavy metals within a protective matrix, interaction with ruminal microorganisms are avoided, thus precluding the necessity for microorganisms to transcribe genes that encode for antimicrobial resistance elements.

The applications above are intended to serve only as examples, and by no means should these be construed as a finite list of applications. The same process could be employed as a means of protecting fat soluble vitamins, enzymes, probiotics, prebiotics, carbohydrates, pharmaceuticals, essential oils, minerals, and other compounds, thus assuring that greater proportions of these products are presented post-ruminally to enhance their desired effects on the host animal or microbial populations in the postruminal tract.

Thus, while the invention has been shown in several of its forms, it is not thus limited but is susceptible to various changes and modifications without deputing from the spirit thereof.

What is claimed is:

1. A method for processing ruminant animal feed which increases the proportion of dietary ingredients present in the feed that are resistant to degradation by ruminal microorganisms, the method comprising the steps of:
combining ruminant animal feed ingredients with a binder composition and a blending aid to thereby form a raw feed mixture;
processing the raw feed mixture so formed into a pellet or pill comprised of agglomerated particles; and
wherein the binder composition is comprised of a calcitic or dolomitic mineral hydrate, either alone or in combination with a companion composition selected from the group consisting of mineral carbonates, mineral oxides, and combinations thereof.

2. The method of claim 1, wherein the binder composition is made up of hydrated lime combined with a mineral carbonate.

3. The method of claim 2, wherein the hydrated lime is selected from the group consisting of high calcium, dolomitic or partially hydrated dolomitic limes produced in a pressure hydrator or in an atmospheric hydrator.

4. The method of claim 2, wherein the hydrated limes are made from a starting material selected from the group consisting of high calcium lime, magnesium lime, calcitic dolomitic lime and dolomitic lime.

5. The method of claim 1, wherein the raw feed mixture is processed by means of a pin mixer, pellet mill, disc pelletizer, drum pelletizer, extruder, or other device suitable for producing agglomerated particles.

6. The method of claim 1, wherein the blending aid is water.

7. The method of claim 1, wherein the blending aid is a high moisture content ingredient which contains water.

8. The method of claim 1, wherein the blending aid is a non-aqueous solvent.

9. The method of claim 1, wherein the binder composition is comprised of a mixture of hydrated lime and a calcitic or dolomitic carbonate mineral material.

10. The method of claim 9, wherein the carbonate mineral material is selected from the group consisting of calcium carbonate, magnesium carbonate, dolomite and mixtures thereof.

11. The method of claim 1, wherein the binder composition is about 40% by weight hydrated lime and 60% by weight dolomitic limestone.

12. The method of claim 1, wherein the agglomerated particles have a secondary coating applied after agglomeration.

13. The method of claim 12, wherein the agglomerated particles are exposed to carbon dioxide during processing to thereby yield a final product which contains a greater proportion of mineral carbonates which are basically ruminally inert.

14. The method of claim 1, wherein the agglomerated particles include lysine, methionine or other amino acids as a means of increasing the proportion of those compounds that are available for absorption in the animal postruminal tract.

15. The method of claim 1, wherein the agglomerated particles include choline and water soluble vitamins that may be required by the animal in quantities that exceed those which would normally escape digestion by ruminal microbes.

16. The method of claim 1, wherein the agglomerated particles so produced provide for the protection of monounsaturated or polyunsaturated lipids which normally are extensively biohydrogenated by ruminal microorganisms to yield saturated lipids.

17. The method of claim 1, wherein the agglomerated particles so produced provide for the protection of fat soluble vitamins, enzymes, probiotics, prebiotics, carbohydrates, pharmaceuticals, essential oils, minerals, and other compounds which assure that a greater proportion of these products are presented post-ruminally.

18. A ruminat animal feed, comprising:
ruminant animal feed ingredients combined with a binder composition and water to thereby faint a raw feed mixture, the raw feed mixture so formed being processed into a processed feed pellet comprised of agglomerated particles;
wherein the binder composition is comprised of a calcitic or dolomitic mineral hydrate, either alone or in combination with a companion composition selected from the group consisting of mineral carbonates, mineral oxides, and combinations thereof; and
wherein the so processed agglomerated particles are effective to increase the proportion of dietary ingredients present in the feed that are resistant to degradation by ruminal microorganisms.

19. The ruminant animal feed of claim 18, wherein the binder composition is comprised of dolomitic hydrated lime combined with a companion material selected from the group consisting of calcium carbonate, magnesium carbonate, dolomite and mixtures thereof.
